(19) United States
(12) Patent Application Publication
(10) Pub. No.: US 2002/0110258 A1
(43) Pub. Date: Aug. 15, 2002

(54) Loudspeaker or microphone diaphragm

(76) Inventor: Grzegorz Pol, Parsippany, NJ (US)

Correspondence Address: Mr. Walter J. Tencza Jr., Suite 3, 10 Station Place, Metuchen, NJ, 08840, US

(21) Appl. No.: 09/780,728

(22) Filed: Feb. 9, 2001

(51) Int. Cl. H04R 9/08; H04R 1/00; H04R 11/02

(52) U.S. Cl. 381/423; 381/355; 381/396

(57) ABSTRACT

An apparatus is disclosed comprising a diaphragm for use in a loudspeaker or a microphone. The diaphragm may be constructed as a sealed structure which forms two chambers. A vacuum can be formed in the two chambers. A gas can be added to each of the chambers. The gas may be an inert gas such as neon or krypton. The diaphragm may be comprised of a material having a low density to stiffness ratio. The diaphragm may be comprised of diamond, beryllium, magnesium, or carbon fiber. The structure of the diaphragm may include two portions. The first portion may be in the shape of an indented donut having a cross section of two partial ellipses. The second portion may have an extended oval cross section. The two portions of the diaphragm may alternatively be comprised of a substantially egg shaped portion and a substantially cylindrical portion with a cone portion. The diaphragm may be constructed by a process such as physical vapor deposition or the like.

### FIELD OF THE INVENTION

This invention relates to methods and apparatus for improving loudspeaker or microphone diaphragms.

### BACKGROUND OF THE INVENTION

In the prior art a typical loudspeaker or microphone diaphragm is a single wall with a thickness of about 0.3 to 0.8 millimeters. The diaphragms are typically made of carbon fiber, kevlar, aluminum, or recently as a sandwich (matrix composite). Decreasing the thickness of the single wall causes these materials to flex more and results in more undesirable distortion.

### SUMMARY OF THE INVENTION

The present invention in various embodiments provides a method and an apparatus for improving the transfer from electrical energy to acoustic energy in the field of loudspeakers and microphones.

An apparatus is disclosed comprising a diaphragm for use in a loudspeaker or a microphone. The diaphragm may be constructed as a sealed structure and may be made of a material having a low density to stiffness ratio such as beryllium, magnesium, carbon fiber, diamond, or an aluminum graphite or an alloy of one of these materials. The low density to stiffness ratio may be less than 0.01 where the density is measured in grams/centimeter³ and the stiffness is measured in Young's modulus (Giga Pascals). For example, diamond has a density of 3.51 g/cm³ and a Young's modulus of 1000 GPa, and thus has a density to stiffness ratio of 0.00351. Berylium has a density of 1.6 g/cm³ and a Young's Modulus of 320 Gpa, and thus a density to stiffness ratio of of 0.005.

The diaphragm can be constructed using one or more of nano-material processes such as chemical vapor deposition, physical vapor deposition, cold chemical vapor deposition, plasma assisted physical vapor deposition, plasma ion vapor deposition, laser assisted vapor deposition, or another type of nano-material process. The material for constructing the diaphragm should have a compression strength value which is similar to the material's tensile strength value. Great differences between compression strength value and tensile strength value can cause excessive distortion. A material should be chosen which has the smallest difference between the compression strength value and the tensile strength value for that material. If the material is aluminum graphite, it should have a thermal expansion close to zero. The diaphragm may include one, two or more chambers which are sealed and in which vacuums may be placed. Alternatively, in one embodiment after a vacuum has been formed in the one or more chambers, a noncombustible gas can be placed in each chamber.

If the material used for the diaphragm is one or more of beryllium, magnesium, carbon fiber, diamond, or an aluminum graphite, the diaphragm can be constructed by chemical vapor deposition (“CVD”), which is a process generally known.

The structure of the diaphragm may include a first portion in the shape of an indented donut and a second portion in the shape of a cylinder bound by parabolic shaped cones, one at each end of the cylinder. The first portion may have a cross section which is in the form of two partial ellipses. In order to form the indented donut structure the two partial ellipses, which are symmetrical, may be rotated around an axis of symmetry. The diaphragm may alternatively be comprised of a first portion which is shaped like an egg shell and a second portion which is substantially cylindrical, with one end bound by a parabolic shaped cone. The egg shell shaped portion may have an oval cross section. The egg shell shape can be formed mathematically by rotating the oval cross section around an axis of symmetry. The oval cross section may be a Cassini Oval or a Cartesian Oval.

The damping properties of the diaphragm in embodiments of the present invention are better than the prior art and provide an increase from the prior art by providing a vacuum inside the diaphragm. The diaphragm shapes and configurations also aid in damping properties. The diaphragm is comprised of at least one sealed enclosure where a vacuum can be provided which causes prestressing of the walls of the diaphragm. The prior art only provided for one wall and did not provide for a sealed enclosure for a diaphragm.

The natural resonance frequency of the diaphragm in accordance with embodiments of the present invention can be manipulated by applying different amounts of vacuum pressure into the chambers of the diaphragm, by manipulating different vacuums in both chambers or by applying different noncombustible gases to the chambers. The walls of the chambers can be pre-stressed by over pressure, such as by supplying air at a pressure above atmospheric pressure. Also noncombustible gasses can be applied to the chambers at atmospheric pressure. These noncombustible gasses can be supplied at atmospheric pressure, at least in part, to create better damping properties for the diaphragm.

If diamond is used, the diamond material is three to four times stiffer than materials previously used in the prior art for loudspeaker diaphragms.

Using a structure for the diaphragm comprised of one or more chambers as opposed to a single wall as in the prior art, increases the stiffness of the diaphragm significantly (possibly by a factor of three). The use of a vacuum in accordance with the present invention inside the chamber or chambers of the diaphragm improves stiffness of the diaphragm possibly twice as much as from the prior art. Using the structure as opposed to the single wall allows the thickness of the walls to be decreased from the prior art single wall.

The weight of an 89 millimeter diameter egg shell shape berylium diaphragm in the present invention can be at least twenty times less than a single wall berylium diaphragm in the prior art.

Although various shapes for the diaphragm are shown in this application, the final shape of the diaphragm can be determined using a finite element computer simulation by determining which parts of the diaphragm release the most unwanted distortion.

### BRIEF DESCRIPTION OF THE DRAWINGS

FIG. 1 shows a cross sectional view of a loudspeaker or microphone diaphragm in accordance with a first embodiment of the present invention along with a cross sectional view of a movable coil;

FIG. 2 shows a top view of the diaphragm of FIG. 1;

FIG. 3 shows a bottom view of the diaphragm of FIG. 1;

FIG. 4 shows a cross sectional view of a first portion of the diaphragm of FIG. 1;

FIG. 5 shows a cross sectional view of a second portion of the diaphragm of FIG. 1;

FIG. 6 shows a front view of the diaphragm of FIG. 1;

FIG. 7 shows a cross sectional view of a loudspeaker or microphone diaphragm in accordance with a second embodiment of the present invention along with a cross sectional view of a movable coil;

FIG. 8 shows a front view of the diaphragm of FIG. 7; and

FIG. 9 shows a diagram which explains the process of creating an egg shell shape by physical vapor deposition.

### DETAILED DESCRIPTION OF THE DRAWINGS

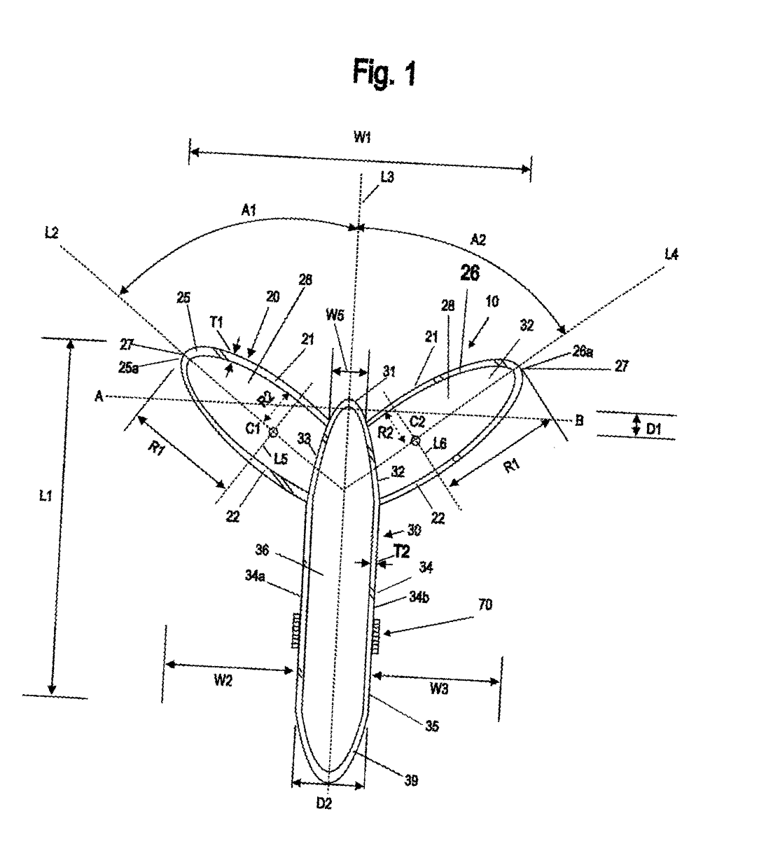

FIG. 1 shows a cross sectional view of a loudspeaker or microphone diaphragm 10 in accordance with a first embodiment of the present invention along with a cross sectional view of a movable coil 70.

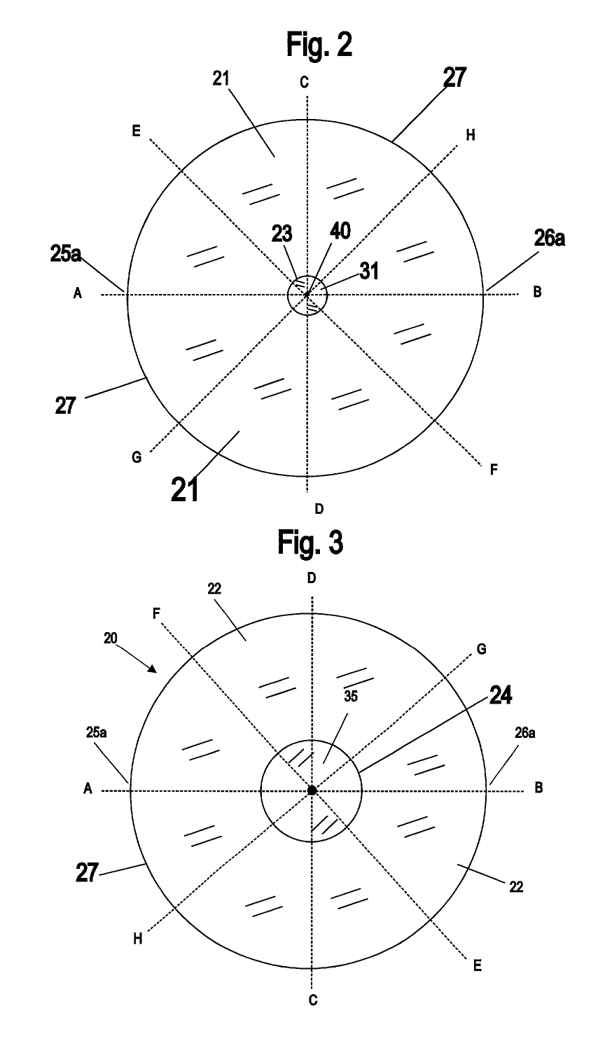

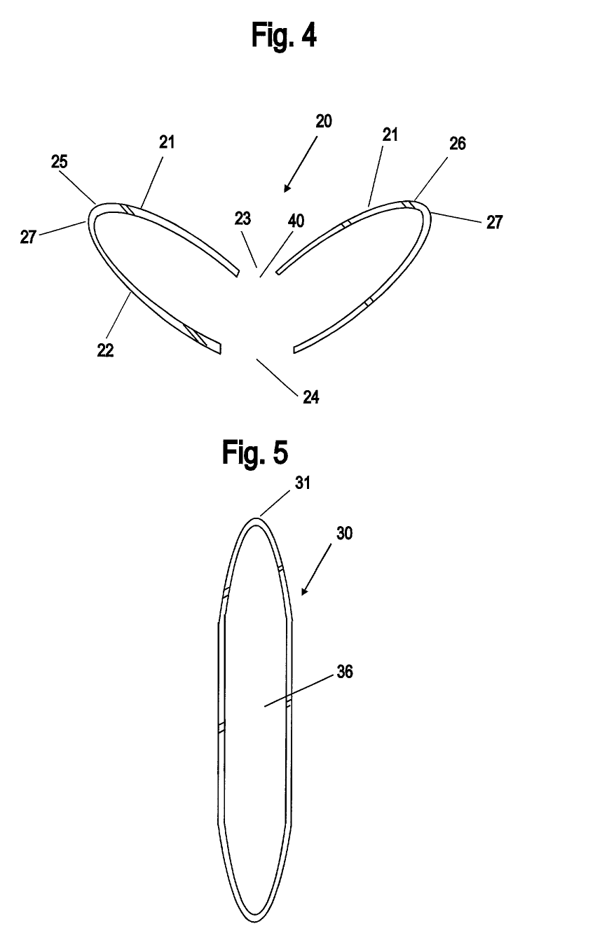

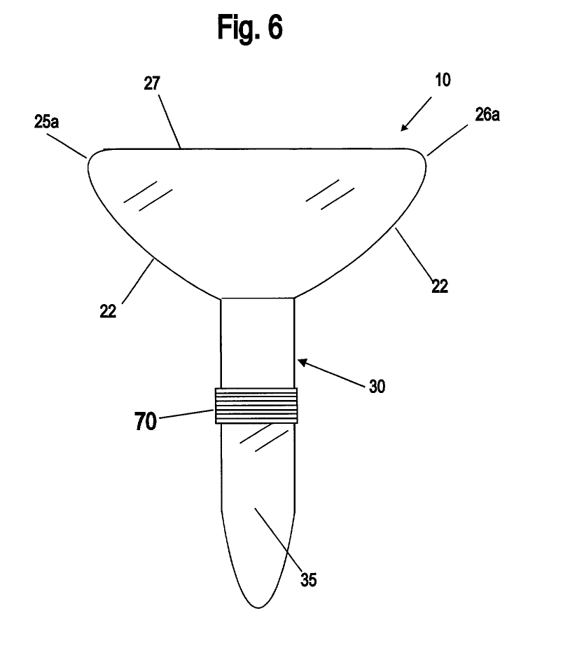

The diaphragm 10 is comprised of first portion 20 and second portion 30. Second portion 30 can be termed a shaft or and extended egg shape structure. A cross section of first portion 20 is shown in FIG. 4 and a cross section of second portion 30 is shown in FIG. 5. Referring to FIGS. 1 and 4, first portion 20 is a single integrated piece which includes a top curved portion 21 and a bottom curved portion 22. The first portion 20 has an indented donut or ring shape. The top curved portion 21 has a circular appearance when viewed from above as shown by the top view of FIG. 2, with the exception of an opening 23 shown in FIG. 4, through which the end 31 of the second portion 30 is inserted. The bottom curved portion 22 has a circular appearance when viewed from below as shown by FIG. 3, with the exception of an opening 24, shown in FIG. 5, through which a portion 35 of the second portion 30 is inserted. The second portion 30 includes a cone section 39.

The top curved portion 21 and the bottom curved portion 22 define a cross section which is in the form of two partial ellipses 25 and 26, as shown by FIG. 1 and FIG. 4. When a cross section of the first portion 20 of the diaphragm 10 is taken along any plane which cuts the first portion 20 into two symmetrical equal pieces, (i.e. in FIG. 1 partial ellipse 25 and partial ellipse 26 are symmetrical about center line L3) and which passes through the center 40 of the first portion 20 (for example as shown in FIG. 4), the cross section will be the same as in FIG. 4. I.e. the cross section of the first portion 20 is uniform through the entire circumference of the circular edge 27 shown in FIG. 2 and 4. The cross section for FIG. 1 has been taken along line AB. The cross section of the first portion 20 will be the same as in FIG. 1 if the plane of the cross section lies along lines CD, EF, or GH, with the plane of the cross section also being parallel to center line L3 in FIG. 1. The three dimensional first portion 20 can be formed mathematically by rotating the two dimensional cross section (partial ellipses 25 and 26) shown in FIG. 1 about the axis of symmetry, which is line L3 in FIG. 1.

A cross section of the second portion 30 of the diaphragm 10 is shown in FIG. 1 and FIG. 5. A three dimensional section portion 30 can be formed mathematically by rotating the two dimensional cross section in FIG. 1 of second portion 30 about the axis of symmetry which is line L3 in FIG. 1. The second portion 30 is comprised of a cone section 32, a cylindrical section 34, and a cone section 39. The second portion 30 has an overall shaft or cylinder appearance with two parabolic-cone shaped ends 32 and 39. Cone section 39 on the bottom is shorter than the cone section 32 on the top. Cone section 39 and cone section 32 should be asymmetrical with respect to one another in order to provide better damping properties for the diaphragm 10.

The second portion 30 is a sealed enclosure in which is located a chamber 36 as shown in FIGS. 1 and 5. When the first portion 20 of the diaphragm 10 is placed, fixed, and sealed, on the second portion 30 as shown in FIG. 1, another sealed enclosure is formed by the outer wall 33 of the cone section 32 of the second portion 30 and the first portion 20 of the diaphragm. Inside this sealed enclosure is chamber 28 shown in FIG. 1.

As mentioned, the cross section of the first portion 20 in FIG. 1 shows partial ellipses 25 and 26, which are mirror images of one another. The partial ellipse 25 has a section to the left of line L5 which is half of an ellipse. The point C1 would be the center of an ellipse if the ellipse was completed. The section to the left of line L5 has a dimension R1 which may be one and three-eighths inches, and a dimension R2 which may be one-half of an inch. Similarly the partial ellipse 26 has a section to the right of line L6 which is half of an ellipse. The point C2 would be the center of an ellipse if the ellipse was completed. The section to the right of line L6 has a dimension R2 and a dimension R1 which may be the same as the same named dimensions for the partial ellipse 25.

FIG. 1 also shows a cross section of movable coil 70. Coil 70 is attached to wall 34a and wall 34b of second portion 30 and is wound around the circumference of the second portion 30.

The diaphragm 10 may have an overall width, W1, which is the width or diameter of the first portion 20, which may be three and one-half inches, from an edge 25a to an edge 26a, directly opposite. The cylinder portion 34 of the second portion 30 of the diaphragm 10 may have a an outer diameter, D2, which may be one inch. Each partial ellipse cross section, such as partial ellipse 25 may be at angle A1, with respect to the center line L3 going through the center of the second portion 30 of the diaphragm 10 as shown by FIG. 1. Line L2 going through the point C1 of the partial ellipse 25 cross section may be at an angle A1 which may be fifty-three degrees with respect to the center line L3. Similarly, line L4 shown going through the point C2 of the partial ellipse 26 cross section may be at an angle A2 which may also be fifty-three degrees with respect to the center line L3. The first portion 20 should be uniform so that other partial ellipse cross sections which comprise the first portion 20 of the diaphragm 10 should also be at an angle A1 with respect to the center line L3 (for example if the cross section were taken along lines CD, EF, or GH, should in FIG. 2).

The end 31 of the second portion 30 may extend a distance of D1, which may be about three-sixteenths of an inch or less, above where the first portion 20 and the second portion 30 are fixed and sealed together at the first opening 23, shown in FIG. 4 of the first portion 20. The end 31 may have a width of W5, again at the location of the first opening 23, which may be three-eighths of an inch. The opening 23 shown in FIG. 4, may also be about three-eighths of an inch. Referring to the cross section shown in FIG. 1, the outer edge 25a and the outer edge 27 of the first portion 20 may extend out horizontally a distance, W2, from the wall 34a of the second portion 30, where W2 may be one and one quarter inches. The outer edge 26a and generally the outer edge 27 of the first portion 20 may extend out horizontally a distance, W3, from the wall 34b of the second portion 30, where W3 may be one and one quarter inches.

The first portion 20 and the second portion 30 of the diaphragm 10 may be made by a chemical vapor deposition process as a thick film free standing structure. The diaphragm 10 can be a free standing structure. Each wall of the first portion 20 and the second portion 30, such as the curved portion 21, the curved portion 22, the end 31, the section 32, 34, and 39, may have a thickness of T1, shown in FIG. 1, which can be fifteen to twenty-five micrometers. Generally, the thickness of the structure, including the first portion 20 and the second portion 30, depends on the material used in the chemical vapor deposition (“CVD”) process, the grain size of the materials used, and the particular “CVD” technology used.

The first portion 20 and the second portion 30 may be made of diamond, beryllium, magnesium, carbon fiber, or aluminum graphite with close to zero thermal expansion or can be made of a matrix composite as a sandwich having an open cell low weight carbon fiber such as a fiber coated on both sides with layers of materials mentioned before. The walls of the first portion 20 or second portion 30 can be made of a sandwich of open cell lowest weight carbon fiber or lowest weight aerogel in between inner and outer layers of diamond. As another example, the walls of the first portion 20 or second portion 30 may be comprised of a sandwich of an outer layer of four micrometers thickness of diamond, a center layer of ten micrometers thickness of carbon fiber, and an inner layer lining the inside of the chamber (28 or 36 for example) of two micrometers thickness of diamond. Such a sandwich should not be permeable. The center layer could be a low weight or low density carbon fiber, having for example 0.15 gram/cm³. The first portion 20 and the second portion 30 should be made of a material having a low weight or a low density but a high stiffness, i.e. a low density to stiffness ratio, which can be less than 0.01 where the density is measured in grams/cm³ and the stiffness is measured in Young's Modulus.

In operation, the movable coil 70 moves to cause the vibration of diaphragm 10. The vibration of diaphragm 10 causes acoustic waves or sound. For a loudspeaker, electric energy causes the movable coil 70 to move which causes the diaphragm 10 to vibrate and thus to transmit acoustic waves. For a microphone, the diaphragm 10 receives acoustic waves or acoustic energy and vibrates. The vibration of the diaphragm 10 causes movement of the movable coil 70 which causes electrical energy to be generated in the movable coil 70.

In accordance with an embodiment of the present invention, the air is sucked out of the chamber 28 shown in FIG. 1 inside the first portion 20 and the chamber 36 of the second portion 20. Air can be sucked out by first making a hole with a laser through for example section 34 into chamber 36, sucking out the air from chamber 36 and then plugging in the hole that was made by the laser in the section 34. The air can be sucked out until there is a vacuum in chamber 36 or until there is substantially a vacuum in chamber 36. The hole can be plugged to preserve a vacuum or substantial vacuum. In a similar manner, a hole can be made by a laser in for example curved portion 21 into chamber 28, air can be sucked out to form a vacuum in chamber 28, and then the hole made by the laser in curved portion 21 can be plugged in to preserve a vacuum or substantial vacuum in chamber 28. One may be able to make a hole with a laser through cone section 32 at a location which intersects with first portion 20, so that air can be sucked out of chambers 28 and 36 simultaneously, or a non combustible gas can be applied to chambers 28 and 36 simultaneously to create equal pressure in chambers 28 and 36.

In one embodiment of the present invention a vacuum is formed in chambers 28 and 36 and then the diaphragm 10 is used for a loudspeaker or a microphone. However, in another embodiment of the present invention, air can be removed from the chambers 28 and 36 and a noncombustible gas, such as an inert gas is inserted into the chambers 28 and 36. A hole can be made by a laser in section 34 into chamber 36 and a gas can be forced to flow into chamber 36, and then the hole can be plugged to preserve the gas in the chamber 36. Similarly a hole can be made by a laser in portion 21, gas can be forced to flow into chamber 28 and then the hole can be plugged in to preserve the gas in chamber 28. One may be able to make a hole with a laser into cone section 32 at a location which intersects with first portion 20, so that a gas can be applied to chambers 28 and 36 simultaneously to create equal pressure in chambers 28 and 36.

Chambers 28 and 36 may be united by making holes in the cone section 32 that normally forms the boundary for chamber 28 so that air or gas can pass from chamber 28 to chamber 36 or vice versa. This can be done to create equal pressure in the two chambers 28 and 36.

The gas inserted into chambers 28 and 36 can be noncombustible. Neon can be inserted into both chambers 28 and 36, or krypton can be inserted into chambers 28 and 36. The particular kind of gas, the gas volume, and the gas pressure to be used may be determined later based on the self resonance we would like to receive from the structure of diaphragm 10.

The second or shaft portion 30 of FIG. 1 can be used alone as a diaphragm without the first portion 20 of FIG. 1.

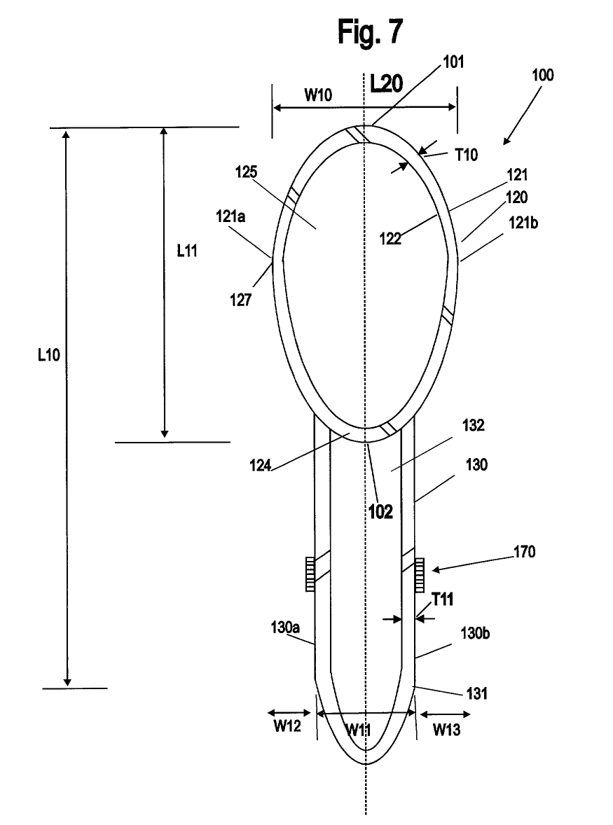

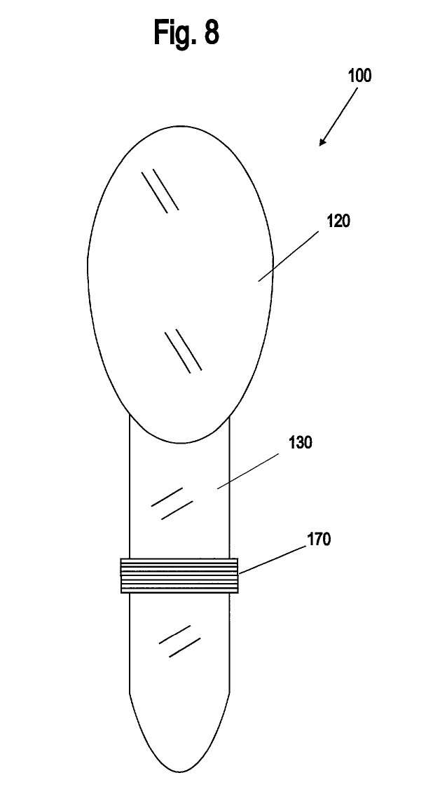

FIG. 7 shows a cross sectional view of a loudspeaker or microphone diaphragm 100 in accordance with a second embodiment of the present invention along with a cross sectional view of a movable coil 170 and FIG. 8 shows a front view of the diaphragm 100 of FIG. 7. The diaphragm 100 is comprised of a first portion 120 and a second portion 130. The first portion 120 is shaped like an egg shell. The second portion 130 is substantially cylindrical with a parabolic cone section 131 on the bottom, with the first portion 120 inserted in, fixed to, and sealed to the second portion 130. The first portion 120 and the second portion 130 may be joined together by a chemical vapor deposition process. (“CVD”). The three dimensional second portion 130 can be formed mathematically by rotating the two dimensional cross section shown in FIG. 7 about the axis of rotational symmetry which is line L20.

The egg-shell shaped first portion 120 may have an oval cross section as shown in FIG. 7. The egg shell shaped first portion 120 may have an outer surface 121 and an inner surface 122. The outer surface 121 may have an oval cross section and the inner surface 122 may have an oval cross section which is smaller than the oval cross section of the outer surface. The oval cross sections of outer surface 121 and inner surface 122 may be for example Cartesian ovals or a Cassini Ovals. A Cartesian oval is a figure consisting of all those points for which the sum of the distance to one focus plus twice the distance to a second focus is a constant as is known in the mathematical arts. A Cassini oval is a figure consisting of all those points for which the product of their distance to two fixed points (called the foci) is a constant as is known in the mathematical arts. The thin end 102 of the egg-shell shaped first portion 120 is shown inserted into the portion 130. The fat end 101 is opposite the thin end 102.

A three dimensional egg shaped first portion 120 can be mathematically determined by rotating the oval cross section of FIG. 7 about the axis of rotational symmetry for first portion 120.

Instead of an egg shaped first portion 120, a closed structure having a parabolic curve cross section or shape can be used for first portion 120.

The distance, T10, between the outer surface 121 and the inner surface 122, which can be thought of as the thickness of the walls of the first portion 120, can be five to eight micrometers of uniform sprayed layers (sprayed using “CVD” or another vapor deposition process for example) or as little as five hundred nanometers.

The three dimensional first portion 120 forms a sealed enclosure in which there is a chamber 125, whose location is shown in FIG. 7. The second portion 130 along with portion 124 of the first portion 120, forms a sealed enclosure in which there is a chamber 132. Vacuums can be formed in the chambers 125 and 132 similar to the FIG. 1 embodiment. A gas can be placed in chambers 125 and 132 similar to the FIG. 1 embodiment. Similar to the FIG. 1 embodiment vacuums can be independently created in chambers 125 and 132. Vacuums with the same amount of under pressure can be created in chambers 125 and 132 (by for example making a hole at the bottom of the thin part of the egg shaped portion 120 which intersects with portion 130. Alternatively, a vacuum can be provided in both chambers 125 and 132 and then later a noncombustible gas can be placed in chambers 125 and 132.

The movable coil 170 is attached to the second portion 130 and the coil 170 may move to cause vibration of the diaphragm 100 for a loudspeaker or the diaphragm 100 may vibrate to cause movement of the movable coil 170 for a microphone.

The outer width, W10 of the substantially egg shaped structure first portion 120 can be about forty-seven millimeters. The length, L11, of the substantially egg shaped structure first portion 120 may be sixty-one millimeters. The length L10 of the diaphragm 100 may be determined as desired but will be greater than L11. The ratio of the length L11 to the width W10 of the outer egg shell shaped diaphragm 100 may be 1.3. The egg shaped portion outer edge 121 a may extend a horizontal distance of W12 beyond the outer edge 130a of the second portion 130, which may be eleven millimeters and the shaft (also called portion 130) may have a diameter of twenty-five millimeters. The egg shaped portion outer edge 121b may extend a horizontal distance of W13 beyond the outer edge 130b of the second portion 130, which may eleven millimeters. Generally the outer edge 127 may extend a horizontal distance of twenty-two millimeters beyond the outer edge 131 of the second portion 130.

The distance, W11, between the outer edge 130a and the outer edge 130b, i.e. the outer diameter of the second portion 130 may be may be one inch.

The second portion 130 in FIG. 7 has a sufficient width, W11, so that the intersection location between first portion 120 and second portion 130 is resistant to buckling. In the case of a microphone, the prior art lacked the egg shell shape of FIG. 7 and the prior art had a needle type shaft attached to a single wall microphone diaphragm having insufficent width which would be highly subject to undesired buckling or bending. The prior art microphone also lacked a chamber, a vacuum, and many other features of embodiments of the present invention.

It is possible that the second or shaft portion 30 of FIG. 1 can be used without the first or donut shaped portion 20 or vice versa and also that the second portion 130 could be used without the egg shaped portion 120 or vice versa. However, at least one closed chamber is preferred.

FIG. 8 shows a front view of the diaphragm 100. The side views and back view would be the same.

Referring to FIGS. 7 and 8, enforcement can be provided near portions 121a and 121b by adding extra pre-tension layers of long fiber materal in a circular manner to the egg shaped first portion 120. The location of the pre-tension layers near portions 121a and 121b could be the location where the surrounding suspension for the diaphragm 100 can be placed.

Length (similar to L11 in FIG. 7) to width (similar to W10 in FIG. 7) proportion of a regular hen egg is about 1.3 to 1. In accordance with embodiments of the present invention the length to width proportion may range from “1.3 to 1” to “4 to 1” depending on the frequency of the sound waves we would like to receive in the microphone case. The length to width proportion may range from “0.01 to 1” to “1.3 to 1” depending on the frequency we would like to transmit in the loudspeaker case and to receive in the microphone case.

Egg shells found naturally may range from large egg shells having a length of one hundred eighty millimeters and a width of one hundred forty millimeters to small egg shells having a length of thirteen millimeters and a width of eight millimeters. Such egg shells can be used as a ready substrates for chemical vapor deposition processes for making the diaphragm.

Decreasing the weight of either diaphragm 10 or 100 decreases either diaphragm's inertia and thus allows for a faster acceleration time for either diaphragm and shortens the distance of acceleration during the excursion of either diaphragm, which reduces distortion, i.e. the sound produced or received is more accurate.

The ideal diaphragm for loudspeakers and microphones would be massless and as stiff as possible. Obviously this is not possible. However, the present invention comes closer to the ideal by providing a significantly lower weight or a lower density and signficantly stiffer diaphragm than the prior art. As far the inventor is aware, chemical vapor deposition processes and like processes have not been used in the prior art to make a loudspeaker or microphone diaphragm structure.

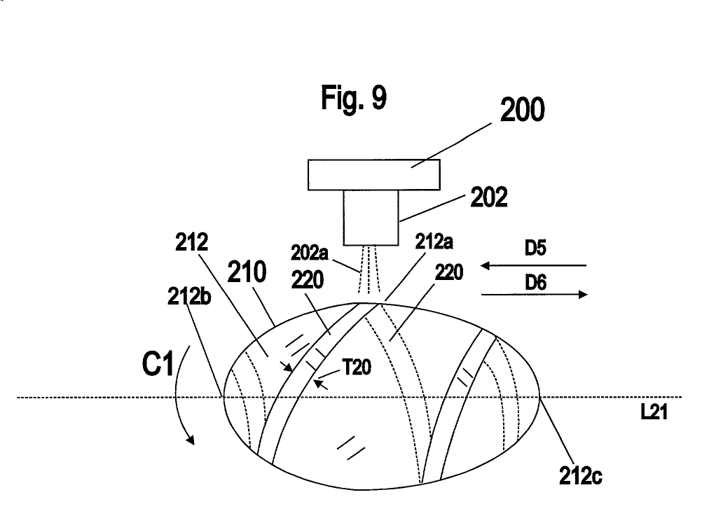

A vapor deposition process such as a physical vapor deposition process in accordance with an embodiment of the present invention to form an egg shaped shell such as egg shaped portion 120 found in FIG. 7, can be implemented as follows. A real egg shell 210 shown in FIG. 9 can be used as a substrate. The real egg shell 210, having a surface 212, can be rotated in the direction C1, which may be clockwise or counter clockwise, around its center axis of rotation L21. The real egg shell 210 should also oscillate sideways, alternately in the directions D5 and D6, while it is rotating in the direction C1. A spray nozzle 202, for a physical vapor deposition spray device 200, can spray vapor onto the surface 212 of the real egg shell 210. The vapor then hardens into a solid. The rate of application of the physical vapor shown by the dashed lines 202a, should vary from high when a central portion such as portion 212a of the egg 210 is nearest the spray nozzle 202 to low when an end portion, such as portion 212b or 212c of the egg 210 is nearest the spray nozzle 202. The speed of rotation of the egg 210 should be steady in this case. This allows a uniform thickness to be applied to the real egg 210 and thus allows a uniform thickness egg shell shape, such as first portion 120 in FIG. 7, to be created. The width of a soild layer 220, created by the vapor process, T20, sprayed from the spray nozzle 202 may range from one-fifth to one-sixth of the length of the real egg shell 210 (which is approximately the same as the length L11 of the first portion 120 shown in FIG. 7 which is created by the physical vapor deposition process.) This process will form coil type solid layers 220 as shown in FIG. 9. Dashed lines for coil layers 220 show layers on the other side of the egg 210. These coil type layers 220 provide reinforcement for the egg shell shape portion 120. A number of repeatable layers can be applied and the egg shell 210 will be completely covered by the material supplied by the nozzle 202 when the process is complete. Similarly, the shaft second portion 30 in FIG. 1 can be formed by a similar physical vapor deposition process where a shaft substrate similar to shaft portion 30 is both rotated and oscillated and a physical vapor deposition is applied to form the shaft portion 30. The rate of application of the physical vapor deposition would be decreased at the cone sections 32 and 39 of the shaft portion 30.

It is critical that the thickness T10 of the egg shell shaped portion 120 be uniform to achieve a better vacuum inside the chamber 125. Similarly, it is critical that the shaft shaped portion 30 in FIG. 1 have a uniform thickness T2 so that a better vacuum can be achieved inside the chamber 36 and that the shaft shaped portion 130 in FIG. 7 have a uniform thickness T11 so that a better vacuum can be achieved inside the chamber 132.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a diaphragm for use in receiving or transmitting acoustic waves;
wherein the diaphragm is comprised of a first sealed enclosure in which is located a first chamber.

2. The apparatus of claim 1
wherein the diaphragm is comprised of a second sealed enclosure in which is located a second chamber.

3. The apparatus of claim 1
wherein a presssure under atmospheric pressure is established inside the first chamber.

4. The apparatus of claim 1
wherein a pressure over atmospheric pressure is established inside the first chamber.

5. The apparatus of claim 1
wherein a presssure approximately equal to atmospheric pressure is established inside the first chamber.

6. The apparatus of claim 1
wherein a vacuum is formed in the first chamber.

7. The apparatus of claim 6 wherein
wherein the diaphragm is comprised of a second sealed enclosure in which is located a second chamber;
and wherein a vacuum is formed in the second chamber.

8. The apparatus of claim 1 wherein
wherein the diaphragm is comprised of a material having a density to stiffness ratio less than 0.01, wherein the density is measured in grams/centimeter³ and the stiffness is measured in Young's Modulus in Giga Pascals.

9. The apparatus of claim 8 wherein
the diaphragm is comprised of diamond.

10. The apparatus of claim 8 wherein
the diaphragm is comprised of beryllium.

11. The apparatus of claim 8 wherein
the diaphragm is comprised of magnesium.

12. The apparatus of claim 8 wherein
the diaphragm is comprised of carbon fiber.

13. The apparatus of claim 7 wherein
the diaphragm is comprised of a first portion and a second portion.

14. The apparatus of claim 13 wherein
the first portion is shaped in the form of an indented donut, and has a cross section in the form of two partial ellipses.

15. The apparatus of claim 13 wherein
the second portion includes a first cone section and a second cone section.

16. The apparatus of claim 13 wherein
the first portion is shaped in the form of an egg shell.

17. The apparatus of claim 16 wherein
the second portion is substantially shaped in the form of a partial cylinder.

18. The apparatus of claim 1
wherein a first gas is placed in the first chamber.

19. The apparatus of claim 18 wherein
the first gas is an inert gas.

20. The apparatus of claim 18 wherein
the diaphragm is comprised of a second sealed enclosure in which is located a second chamber;
and wherein a second gas is placed in the second chamber.

21. The apparatus of claim 20 wherein
the first and second gasses are inert gasses.

22. The apparatus of claim 19 wherein
the first gas is neon.

23. The apparatus of claim 21 wherein
the first gas and second gasses are neon.

24. A method comprising the steps of
constructing a diaphragm for use in receiving or transmitting acoustic waves comprised of a first chamber;
sucking the air out of the first chamber to form a vacuum; and
using the diaphragm to receive or transmit acoustic waves.

25. A method comprising the steps of
constructing a diaphragm for use in receiving or transmitting acoustic waves comprised of a first chamber;
placing a gas into the first chamber; and
using the diaphragm to receive or transmit acoustic waves

26. The apparatus of claim 1
wherein the diaphragm is comprised of an egg shell shape.

27. The apparatus of claim 26
wherein the egg shell shape has an extended egg shell shape.

28. The apparatus of claim 26
wherein the egg shell shape has an outer surface and an inner surface which have a cross section of a Cartesian oval.

29. The apparatus of claim 26
wherein the egg shell shape has an outer surface and an inner surface which have a cross section of a Cassini oval.
